(19) United States
(12) Patent Application Publication
(10) Pub. No.: US 2016/0245493 A1
(43) Pub. Date: Aug. 25, 2016

(54) Airflow Heatsink For Led Devices

(71) Applicants: Brian Eustace, Sierra Madre, CA (US); Michael Davis, Running Springs, CA (US); Christian Jensen, Running Springs, CA (US)

(72) Inventors: Brian Eustace, Sierra Madre, CA (US); Michael Davis, Running Springs, CA (US); Christian Jensen, Running Springs, CA (US)

(21) Appl. No.: 14/025,466

(22) Filed: Sep. 12, 2013

(51) Int. Cl. F21V 29/00

(52) U.S. Cl. CPC F21V 29/22

(57) ABSTRACT

Disclosed is an LED lighting system with improved airflow and heat dissipation qualities. In one embodiment, the system comprises a heatsink mounted to an LED chip, and a fan assembly blowing air into the heatsink. The fan assembly includes a plurality of fans, the wind tunnels of the plurality of fans providing greater airflow in the center of the heatsink than a conventional one-fan configuration. In a further aspect, the disclosed system comprises a light head assembly in which cool air enters the light head assembly via the bottom and rear, and hot air is drawn out of the top of the light head assembly. An airflow path is created by selectively placing fans, baffles, walls, and openings in the lighting assembly.

### TECHNICAL FIELD

This invention relates to the field of heat dissipation, and more particularly to the field of heat dissipation systems used to cool LED-based lighting systems.

### DESCRIPTION OF THE RELATED ART

Light-emitting diodes (LEDs) have become increasingly popular in lighting applications. Some reasons for this include the fact that LEDs are generally more cost-effective, space-efficient, ecologically friendly, durable, and longer lasting than traditional incandescent or fluorescent lights, while also generating less heat. Although LED's generally generate less heat than other light sources, they still require cooling. Additionally, as LED lighting technology has progressed to produce greater light output using LEDs, there is a growing need for more efficient heat dissipation and cooling of these LED-based lighting systems.

Previous heat dissipation systems in LED lighting systems have utilized passive heatsinks. These heatsinks are generally made of heat-conducting material and generally include a flat front surface that is in contact with an LED chip, and a rear surface with a plurality of extensions. The physical contact between the heatsink and the LED chip draws heat away from the LED chip, and the plurality of extensions provide surface area for dissipating the heat into the surrounding air. Active heatsinks (i.e., power-consuming heatsinks) generally provide a fan to blow air through the plurality of extensions to increase the heat dissipating effects. However, active heatsinks generally include a single fan blowing into the heatsink. A single fan creates a wind tunnel that has a dead spot in the center, which is generally the hottest region of a heatsink. As such, the heat dissipating effects of these active heatsinks are not maximized.

Additionally, in LED-based lighting systems, the LED chip and heatsink are generally enclosed in a confined space. As such, the air around the LED chip and heatsink quickly becomes very warm, which hinders cooling of the LED chip.

### BRIEF SUMMARY OF THE DISCLOSURE

According to various embodiments, the apparatus, systems, and methods described herein relate to heat dissipation and cooling of LED systems.

This invention may be embodied in an LED light assembly comprising an LED chip having a front surface and a rear surface and one or more LEDs on the front surface; a heatsink having a front surface, a rear surface, and a plurality of heatsink extensions extending from the rear surface, wherein the front surface of the heatsink is in physical contact with the rear surface of the LED chip; and a fan assembly positioned proximate the plurality of heatsink extensions. The fan assembly may comprise a plurality of fans that create wind tunnels when operated such that the wind tunnels overlap near a central region of the heatsink.

In one aspect of this embodiment, the LED chip may have a wattage of greater than 400 W. The LED chip may also be a tungsten frequency LED chip, or, alternatively, a daylight frequency LED chip.

In another aspect of this embodiment, the LED light assembly may be configured for use with the DMX512 communication standard.

In a third aspect of this embodiment, the plurality of fans may be low-noise fans. The plurality of fans may also be arranged in a planar pattern. In a further aspect, the plurality of fans may be four fans arranged in a square pattern.

In a fourth aspect of this embodiment, the heatsink may be a flared pin design, a straight pin design, a flared fin design, or a straight fin design.

The present invention may also be embodied in an LED-based lighting system comprising an LED subassembly and a light head subassembly for enclosing the LED subassembly. The LED subassembly may comprise the components and characteristics of the LED light assembly embodiment discussed above. The light head subassembly may comprise an outer enclosure, an inner baffle house within the outer enclosure, and a second fan assembly having one or more fans. The inner baffle may comprise an open region through which air may pass, and the second fan assembly may be positioned proximate the open region of the inner baffle. In this embodiment, an air path may be created by the LED subassembly and the light head subassembly such that air is drawn into the light head subassembly and directed towards the heatsink by the LED subassembly's fan assembly, and air is drawn through the open region and out of the light head subassembly by the light head subassembly's fan assembly. In one aspect of this embodiment, the open region of the inner baffle may have a perforated surface so as to minimize light leak through the open region.

Other features and aspects of the invention will become apparent from the following detailed description, taken in conjunction with the accompanying drawings, which illustrate, by way of example, the features in accordance with various implementations.

### BRIEF DESCRIPTION OF THE DRAWINGS

The drawings are provided for purposes of illustration only and merely depict typical or example implementations. These drawings are provided to facilitate the reader's understanding and shall not be considered limiting of the breadth, scope, or applicability of the invention. For clarity and ease of illustration, these drawings are not necessarily to scale.

FIGS. 1A and 1B provide front and rear perspective views, respectively, of an LED subassembly, in accordance with an embodiment of the present invention.

FIGS. 2A-D provide front, rear, side, and top views, respectively, of the LED subassembly of FIG. 1.

FIG. 3 provides a deconstructed assembly view of the LED subassembly of FIG. 1.

FIGS. 4A-B provide front and rear perspective views, respectively, of a light head assembly, in accordance with an aspect of an embodiment of the present invention.

FIG. 5 provides a deconstructed assembly view of the light head assembly of FIG. 4.

FIGS. 6A-B provide front and rear perspective views, respectively, of the LED heat sink assembly of FIG. 1 inserted into the light head assembly of FIG. 4, in accordance with an embodiment of the present invention.

### DETAILED DESCRIPTION

In the following description, numerous specific details are set forth to provide a thorough understanding of various embodiments of the present invention. It will be apparent however, to one skilled in the art, that these specific details need not be employed to practice various embodiments of the present invention. In other instances, well known components or methods have not been described in detail to avoid unnecessarily obscuring various embodiments of the present invention.

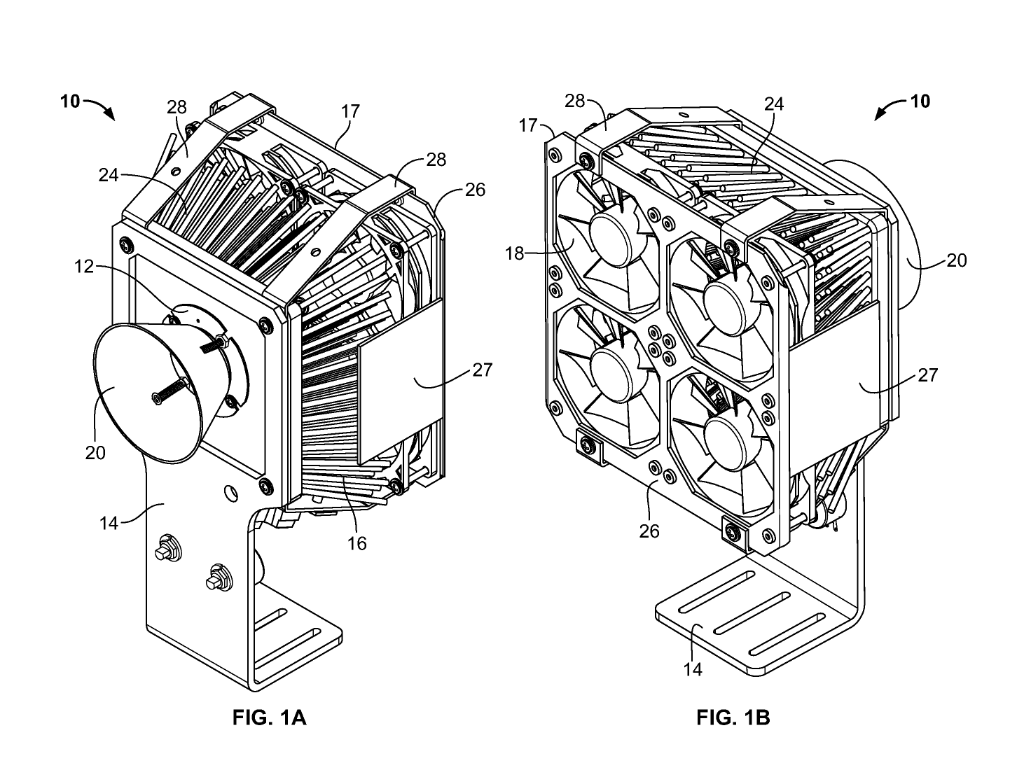

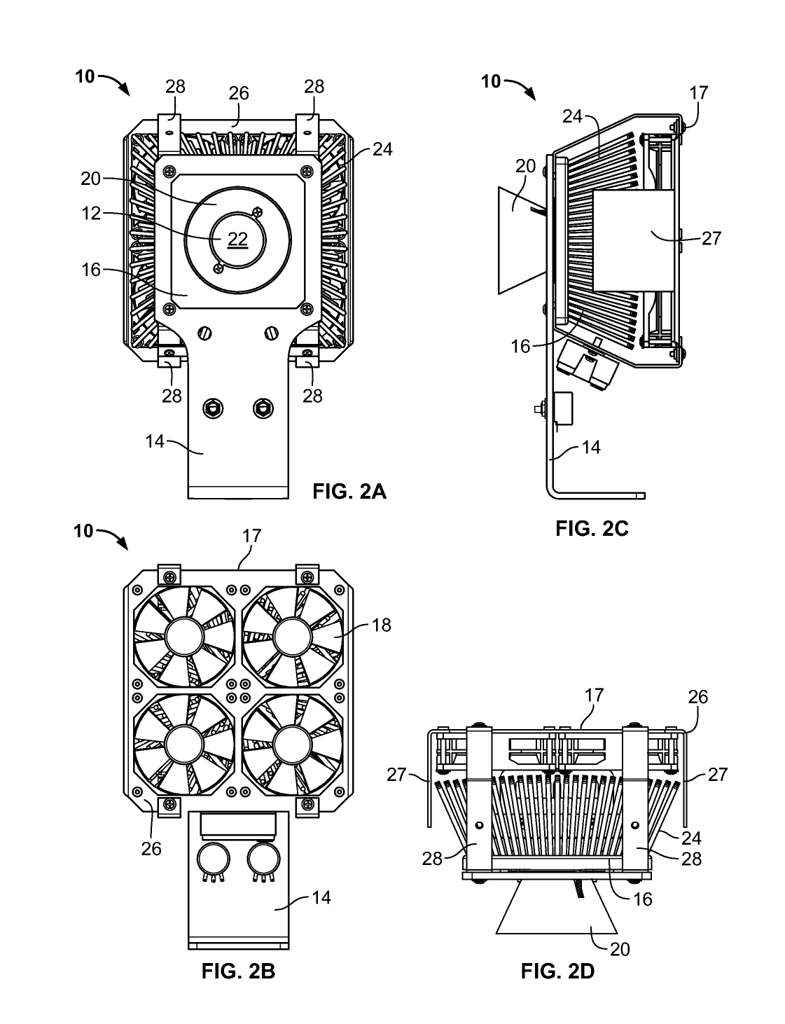

The present invention provides a heat dissipation system for an LED-based lighting system. FIGS. 1A and 1B provide front and rear isometric views of an LED subassembly 10 that embodies certain aspects of the disclosed system. FIGS. 2A-D provide front, rear, side, and top views, respectively, of the LED subassembly 10.

The LED subassembly 10 includes an LED chip 12 and a heatsink 16. The LED chip 12 is generally an electrical chip having a front surface and a rear surface and one or more LEDs 22 centered on the front surface of the chip to produce light output. The heatsink 16 has a flat planar portion having a front surface and a rear surface. The front surface of the heatsink 16 is in contact with the rear surface LED chip 12. The heatsink 16 is generally composed of heat conductive material so that the physical contact between the front surface of the heatsink 16 and the rear surface of the LED chip 12 causes heat from the LED chip 12 to escape into the heatsink 16.

On the front surface of the LED chip 12, a conical reflector 20 surrounds the one or more LEDs 22 so as to intensify and direct the LED light output in a particular direction. The LED chip 12 and the conical reflector 20 occupy a central region on the front surface of the heatsink 16. The outer edges of the heatsink's front surface are then mounted to a relay mounting bracket 14. The relay mounting bracket 14 allows the LED subassembly 10 to be positioned inside a light head assembly, which will be described in greater detail later in this invention.

On the rear surface of the heat sink, opposite the LED chip, are a plurality of flared pins 24. The pins 24 on the rear surface of the heatsink 16 are also made of heat conducting material and provide increased volume to draw heat away from the LED chip 12, and increased surface area through which heat may dissipate into the surrounding air. The heatsink 16 displayed in FIGS. 1 and 2 is a flared pin fin design, with individual pins flaring outwardly from the rear surface of the heatsink 16. However, it should be understood that the principles disclosed herein may be applied to many different heat sink designs, including, but not limited to, straight pin fin (columnar pins extending perpendicularly from the heatsink surface), straight fin (planar fins extending perpendicularly from the heatsink surface) and flared fin (planar fins flaring outwardly from the surface of the heatsink) designs.

Also on the rear side of the heatsink 16, proximate the pins 24, is a fan assembly 17. The fan assembly 17 includes four fans 18 mounted to the LED subassembly 10 by a fan frame 26. The heatsink 16 is generally made of a heat-conductive material that is able to draw heat away from the LED chip 12. The fans 18 blow air through the pins 24 on the heatsink 16 to increase the rate of heat dissipation by the heatsink 16. Although the figures shows a four-fan assembly, the design may use more than 4 fans (e.g., six or eight fans), or reduce the number of fans (e.g., 2 or 3) to provide the same or similar effects in improving the efficiency of cooling the heatsink.

Previously, active heatsink designs used in LED lighting applications have included a heatsink attached to a single fan blowing air into the pins or fins of the heatsink. However, this single-fan design blows a donut-shaped tunnel of air into the heatsink, which results in an airflow “dead-spot” in the center of the heatsink. This is problematic due to the fact that when an LED chip is centered on a heatsink, the center of the heatsink absorbs the most heat produced by the LED chip, making the center of the heatsink the hottest part of the heatsink. The multiple fan design depicted in FIGS. 1 and 2 creates four tunnels of air, with all four tunnels intersecting at the center of the heatsink 16, creating optimal heat dissipation in the hottest region of the heatsink.

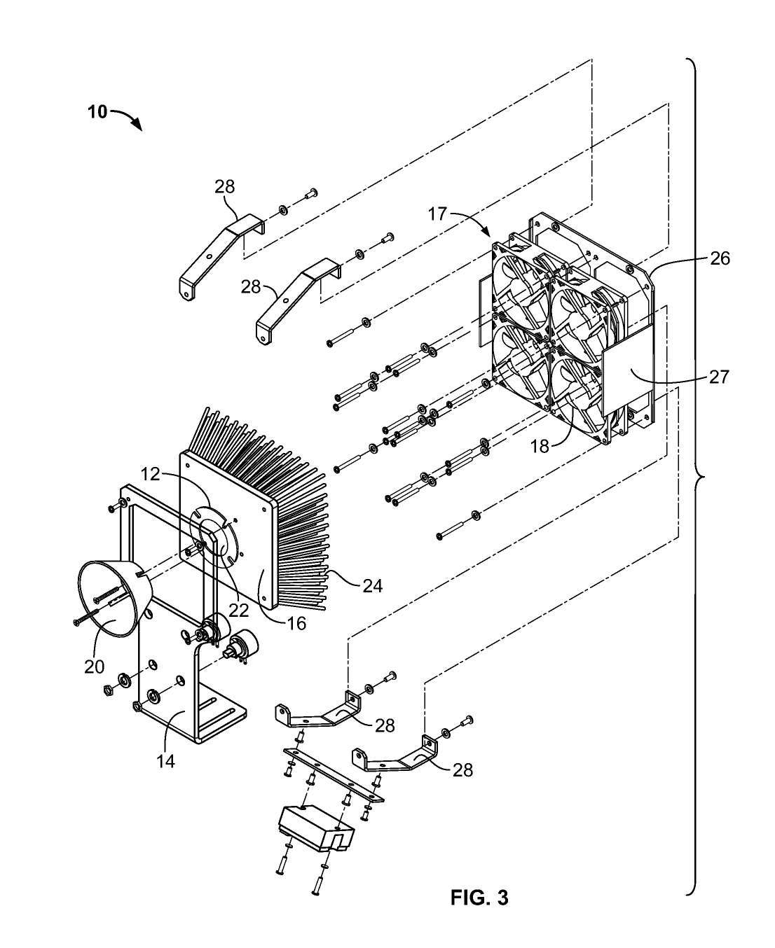

FIG. 3 provides an exploded assembly view of the LED subassembly 10. As described above, the LED chip 12 has one or more LEDs 22 on its front surface, and its rear surface is mounted to a front surface of the heatsink 16. The conical reflector 20 is also mounted to the front surface of the heatsink 16, around the LED chip 12, to surround the one or more LEDs 22. The LED chip 12 and the conical reflector 20 occupy a central region of the heatsink 16's front surface. The outer edges of the heatsink 16's front surface are then mounted to the relay mounting bracket 14. Four fans 18 are positioned on the rear side of the heatsink 16, proximate the plurality of pins 24. The fans 18 are attached to the fan frame 26 via screws or other attachment means. The fan frame 26 includes four openings on the rear surface that correspond to the positions of the four fans 18, which enable the fans to draw air into the fans towards the heatsink 16. The fan frame 26 also includes two side walls 27, which aid in directing air upwards, the significance of which will be discussed in greater detail later in this invention. Four mounting brackets 28, two on top and two on bottom, are provided to secure the fan frame 26 to the relay mounting bracket 14.

The LED/heatsink subassembly design depicted in FIGS. 1-3 can be applied to any LED lighting system. However, it finds particularly useful application when used in film production. In film applications, LEDs of higher light outputs (i.e., higher lumens) may be desirable so as to provide sufficient lighting on a film set. In these high performance embodiments, the LED chip 12 may have a wattage of greater than 400-1000 W, producing light outputs that are equivalent to 2000 W to 6000 W of incandescent fixture. Future LED light fixtures are expected to use larger power supplies and larger LED chips, resulting in higher wattage output. The wattage in creating LED lights is not limited to these wattage values, and the present invention may be used to more efficiently cool LED lights of greater or lesser wattages.

In particular embodiments, the LED chip 12 may be available in both tungsten and daylight industry standard frequencies. LED chips producing such high light outputs generally require more efficient cooling due to the fact that these high output chips can get very hot. As such, the disclosed heat dissipation system and its increased heat dissipation efficiency works to great advantage in cooling these high performance LEDs. In particular embodiments, it may be desirable for the lighting systems disclosed herein to be compatible with the DMX512 communications standard, which is a commonly used standard for electronically controlling lighting systems in films.

Minimizing sound output is an important consideration when high performance lighting systems are used to aid in audio/visual recording. Typically, fans used to cool a lighting system are primarily responsible for any ambient noise created by the lighting system. A single fan with an inefficient wind tunnel path having a dead-zone in the center of the heatsink would require higher speeds to achieve the desired heat dissipation results. By implementing a four-fan design that more efficiently and effectively cools the lighting system, each of the fans in the presently disclosed system can be run at slower speeds. The slower fan speed reduces the noise created by the heat dissipation system, and, therefore, the overall noise output from the lighting system. In order to decrease the sound output of the lighting system, low noise fans may be used, such as a SilenX 80 MM fan.

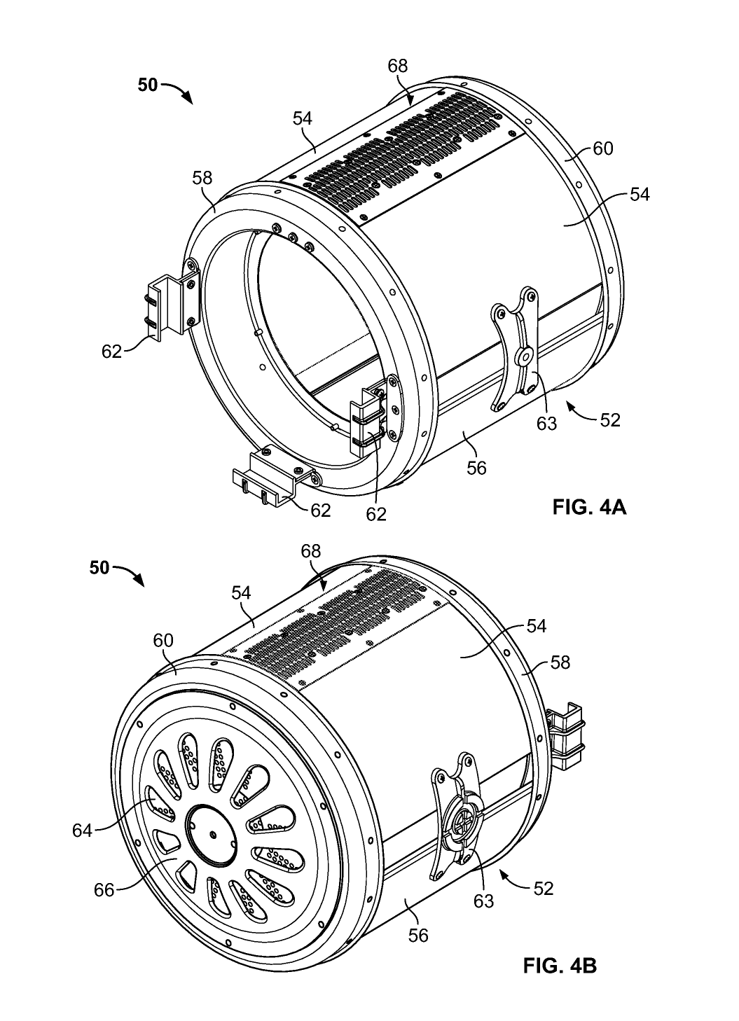

In another aspect of the present invention, a light head assembly is provided for use with the LED subassembly 10 described in FIGS. 1-3. FIGS. 4A and 4B provide front and rear isometric views, respectively, of a light head assembly 50 that may be used to house the LED subassembly 10, in accordance with an aspect of the present invention. The light head assembly 50 is generally hollow and cylindrical in shape, and includes an outer enclosure 52 made up of two upper side panels 54 and two lower side panels 56. On opposing ends of the cylindrical light head assembly 50 are a front ring 58 and a rear ring 60, which assist in holding the outer enclosure components in place.

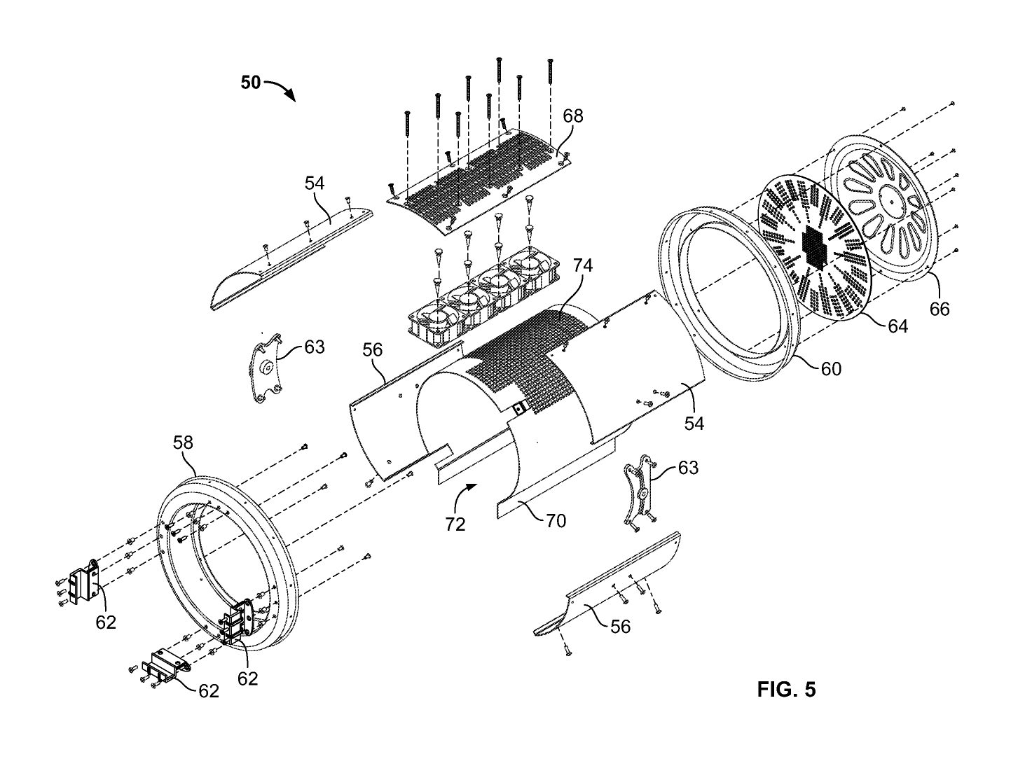

On the front ring 58 are several locking clips 62 to hold lighting accessories, such as fresnel lenses, protective screens, color gel screens, or the like. On the sides of the light head assembly 50 are two trunnion plates 63, which allow the light head assembly 50 to be rotatably attached to a swivel mount. On the rear end of the light head assembly 50 is an inner rear baffle 64 within an outer rear dome 66. On the top surface of the light head assembly 50 is an inline fan assembly 68. Each of these components and their functions will be discussed in greater detail with reference to FIG. 5, which provides an exploded assembly view of the light head assembly 50 to provide a clearer view of its inner-workings.

As can more clearly be seen in FIG. 5, within the outer enclosure of the light head assembly 50 is an inner baffle 70. The inner baffle 70, much like the outer enclosure, is generally cylindrical in shape, but has an opening 72 on its bottom surface. The bottom opening 72 allows for the light head subassembly 10 of FIGS. 1-3 to be inserted into the light head assembly 50. The sides of the cylindrical inner baffle 70 are solid, i.e., closed, but the top surface of the inner baffle 70 has a perforated surface 74 with a plurality of perforated openings. The perforated surface 74 may simply be an opening or any other open configuration. However, a perforated surface may be preferable in certain applications, as the perforated pattern provides some protection with regard to light leaking out of the top of the light head assembly 50.

The perforated surface 74 lies directly beneath the in-line fan assembly 68 of the outer enclosure. These two components work together to form an airflow path within the lighting assembly to maximize heat dissipation within the assembly. The rear of the light head assembly 50, as discussed above, includes an inner rear baffle 64 within a rear dome 66. Both of these components include openings for air to pass through. These openings on the rear of the light head assembly 50 are positioned proximate the fan assembly 17 of the LED subassembly 10.

The fan assembly 17 draws cool, outside air into the light head assembly 50 through the openings in the rear baffle 64 and the rear dome 66. The four-fan configuration of the fan assembly 17 directs this cool airflow to the heatsink 16, with the airflow being focused on the hottest area of the heatsink, its center. The cool air carries heat away from the heatsink 16, allowing the heatsink to draw additional heat away from the LED chip 12. The release of heat into the air results in warming of the air surrounding the heatsink area. The perforated surface 74 on the top of the inner baffle 70 provides a route through which this hot air may escape the light head assembly 50. The in-line fan assembly 68, positioned on the top of the light head assembly 50, is positioned to draw hot air from inside the light head assembly 50 out through the perforated surface 74. Hot air is further directed upwards towards the perforated surface 74 and the in-line fan assembly 66 by the side walls 27 of the fan frame 26 (shown in FIGS. 1-3).

In summary, the fans 18 in the LED subassembly 10, the in-line fan assembly 68, the side walls 27 of the fan frame 26, and the strategic placement of openings in the inner baffle 70 create an airflow path to maximize heat dissipation: (1) cool air is drawn in through the rear of the light head 50 (i.e., inner rear baffle 64 and rear dome 60) by the fans 18 on the LED subassembly 10; (2) the cool air is directed by the fans 18 to the heatsink 16 such that the wind tunnels are focused on the center of the heatsink 16 to carry heat away from the heatsink, resulting in the cool air being warmed; and (3) the now-hot air is drawn out of the light head assembly 50 through the top perforated surface 74 by the in-line fan assembly 68. The flow of air through this path allows for cool air to continually enter the light head assembly 50, while hot air is continually blown out of the light head assembly.

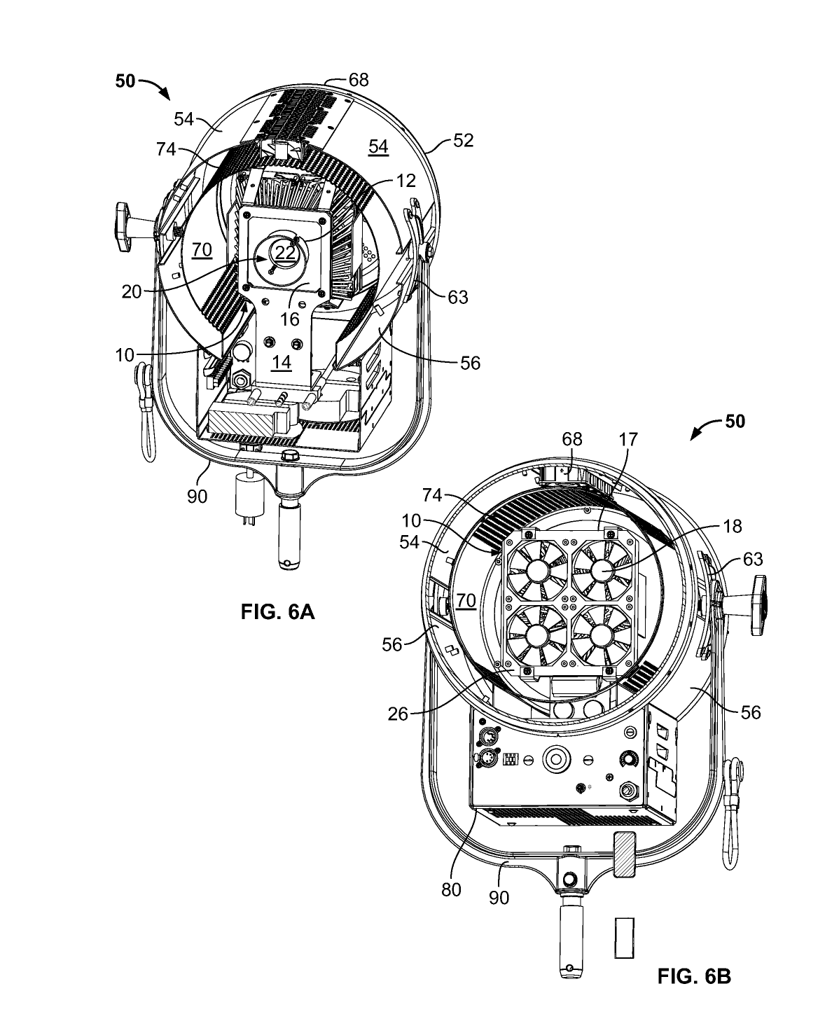

FIGS. 6A and 6B depict the LED subassembly 10 positioned within the light head assembly 50. The LED subassembly 10 is mounted to a trough 80, which is mounted to the light head assembly 50. Controls on the trough 80 allow a user to control operation of the light head assembly 50 (e.g., turning the light on or off, dimming the light, focusing or de-focusing the light beam, etc.). The light head assembly 50 is rotatably mounted on a swivel mount 90, which allows for the direction of the light beam to be adjusted by rotating the light head assembly 50. In FIG. 6A, exterior surfaces on the front of the lighting assembly have been removed to provide a clear view of the LED subassembly 10 mounted in the trough 80 and positioned within the light head assembly 50. In FIG. 6B, the rear portions of the light head assembly 50 (e.g., the inner rear baffle 64 and rear dome 66) have been removed to more clearly show the placement of the LED subassembly 10 within the light head assembly 50.

In the foregoing specification, embodiments of the invention have been described with reference to specific exemplary features thereof. It will, however, be evident that various modifications and changes may be made thereto without departing from the broader spirit and scope of the invention. The specification and figures are, accordingly, to be regarded in an illustrative rather than a restrictive sense. Although the invention has been presented with reference only to the presently preferred embodiments, those of ordinary skill in the art will appreciate that various modifications can be made without departing from this invention. Accordingly, this invention is defined only by the following claims.

1-10. (canceled)

11. An LED-based lighting system comprising:
an LED subassembly comprising
a lighting assembly chip having a front surface and a rear surface and one or more LEDs on the front surface;
a heatsink having a front surface, a rear surface, and a plurality of heatsink extensions extending from the rear surface, wherein the front surface of the heatsink is in physical contact with the rear surface of the lighting assembly chip; and
a first fan assembly positioned proximate the plurality of heatsink extensions, the fan assembly comprising a plurality of fans; and
a light head subassembly for enclosing the LED subassembly, the light head subassembly comprising
an outer enclosure,
an inner baffle housed within the outer enclosure, the inner baffle having an open region through which air may pass, and
a second fan assembly comprising one or more fans positioned proximate the open region of the inner baffle;
wherein air is drawn into the light head subassembly and directed towards the heatsink by the first fan assembly, and air is drawn away from the heatsink, through the open region and out of the light head subassembly by the second fan assembly.

12. The LED-based lighting system of claim 11, wherein, the lighting assembly chip has a wattage of greater than 400 W.

13. The LED-based lighting system of claim 12, wherein the lighting assembly chip has a wattage between 400 W and 1000 W.

14. The LED-based lighting system of claim 11, wherein the lighting assembly chip is a tungsten frequency light assembly chip.

15. The LED-based lighting system of claim 11, wherein the lighting assembly chip is a daylight frequency lighting assembly chip.

16. The LED-based lighting system of claim 11, wherein the LED-based lighting, system is configured to be used with the DMX512 communication standard.

17. The LED-based lighting system of claim 11, wherein the plurality of fans in the first and second fan assemblies are low-noise fans.

18. The LED-based lighting system of claim 11, wherein the open region is a perforated region of the inner baffle.

19. The LED-based lighting system of claim 11, wherein the heatsink is a flared pin design, a straight pin design, a flared fin design, or a straight fin design.

20. The LED-based lighting system of claim 11, wherein the plurality of fans in the first fan assembly are arranged in a planar pattern.

21. The LED-based lighting system of claim 20, wherein the plurality of fans in the first fan assembly are four fans arranged in a square pattern.

22. The LED-based lighting system of claim 21, wherein each of the four fans creates a wind tunnel, and the respective wind tunnels of the four fans overlap near a central region of the heatsink.

23. An LED-based lighting system comprising:
an LED subassembly comprising
a lighting assembly chip having a front surface and a rear surface and one or more LEDs on the front surface,
a heatsink having a front surface, a rear surface, and a plurality of heatsink extensions extending from the rear surface, wherein the front surface of the heatsink is in physical contact with the rear surface of the lighting assembly chip, and
a first fan assembly positioned proximate the plurality of heatsink extensions, the first fan assembly comprising a plurality of fans; and
a light head subassembly comprising
an outer enclosure for housing the LED subassembly, and
a second fan assembly comprising one or more fans;
wherein air is drawn into the light head subassembly and directed towards the heatsink by the first fan assembly, and air is drawn away from the heatsink and out of the light head subassembly by the second fan assembly.

24. The LED-based lighting system of claim 23, wherein the lighting assembly chip has a wattage of greater than 400 W.

25. The LED-based lighting system of claim 23, wherein the lighting assembly chip is a tungsten frequency light assembly chip.

26. The LED-based lighting system of claim 23, wherein the lighting assembly chip is a daylight frequency lighting assembly chip.

27. The LED-based lighting system of claim 23, wherein the LED-based lighting system is configured to be used with the DMX512 communication standard.

28. The LED-based lighting system of claim 23, wherein the plurality of fans in the first fan assembly are arranged in a planar pattern.

29. The LED-based lighting system of claim 28, wherein the plurality of fans in the first fan assembly are four fans arranged in a square pattern.

30. The LED-based lighting system of claim 29, wherein each of the four fans creates a wind tunnel, and the respective wind tunnels of the four fans overlap near a central region of the heatsink.
